(19) United States
(12) Patent Application Publication
(10) Pub. No.: US 2009/0074500 A1
(43) Pub. Date: Mar. 19, 2009

(54) SYSTEM FOR TWO CONSUMER PRODUCTS

(75) Inventors: LEO CLIFFORD PIRES, Basking Ridge, NJ (US); ROGER HWANG, Maple (CA); ABHISEK BASAK, Kolkata (IN); SANTOSH MOHAPATRA, Cuttack (IN)

Correspondence Address: PATTERSON & SHERIDAN L.L.P. NJ Office, 3040 Oak Post Road, Suite 1500, Houston, TX, 77056-6582, US

(73) Assignee: Zen Design Solutions Limited, Wanchai (HK)

(21) Appl. No.: 11/856,682

(22) Filed: Sep. 17, 2007

(51) Int. Cl. B05C 1/00; A45D 40/06; B43K 27/00; B43K 27/02

(52) U.S. Cl. 401/31; 401/17; 401/19; 401/68; 401/35

(57) ABSTRACT

A system for two consumer products, such as cosmetic products, pharmaceutical products, personal hygiene products and adhesive products, among others, is provided. The system provides for convenience in holding, storing and applying stick products and uses two different mechanisms independent of each other to control the two stick products.

### BACKGROUND

1. Field of the Invention

Embodiments of the present invention generally relate to a system for two consumer products. More particularly it relates to a system that provides for convenience in holding, storing and applying two consumer stick products.

2. Description of the Related Art

There are various consumer products that are required to be used consecutively to produce a desired result. For example, in certain areas of make-up one needs to use two cosmetic products consecutively to get a desired look for example, lipliner and lipstick, eyeliner and eye shadow, concealer and foundation are to be applied one after another to get a perfect look. Lipstick is used to enhance the shape and/or the color of the lips and to prevent or minimize substantially the feathering of a lipstick product that is applied to the lips, outlining of lips is done by a separate lip liner product in addition to a lipstick product. Similarly, eyeliner is used after applying eyeshadow to give shape to the eyes and define them as desired. Also, makeup concealer is applied on top of the foundation as it works at concealing or camouflaging facial imperfections. There are such products which are available separately or where they are attached end-to-end as dual-ender products.

Various products are known in the art that provide two cosmetic products in one package. They are generally dual ended so as to contain the two products at the two ends of the container. For example, United States Patent Application No. 2002/0071707 A1 to Breidenbach, et al. discloses a dual ended lip cosmetic applicator which contains a lip product in at least one end of the container. The second end of the dual ended applicator may contain virtually any type of product and can include a lip product, a nail product, a facial product, an eye product, a cosmetic serum, a perfume, etc. U.S. Pat. No. 7,175,359 to Zhang, et al. discloses a cosmeticising pen that contains two different cosmetics in two opposite ends thereof. U.S. Design Pat. No.370,088 to Burns discloses a combination lipstick and lipliner where the two products are present at the two ends of the pen.

In the area of lip cosmetics, there are products that have the lipstick bullet formulated in such a way so as to integrally contain the lipliner that either surrounds the lipstick or is on the periphery of the lipstick for example International Patent Application WO 2002/063992 to Grayson and U.S. Pat. No. 4,740,097 to Kapustin. Similarly, U.S. Pat. No. 6,773,184 to An discloses an integrated lipstick and lip pencil comprising of a lipstick part, a lip pencil part and a coupling part for coupling the lipstick part and the lip pencil part to combine them into one body. It discloses that the components constituting the lipstick and the lip pencil can be separated from each other when shock above a prescribed power is applied by a user to perform their own function.

However, the aforementioned products have been unable to provide the user with a product that allows an easy and convenient application of a make-up routine. For example, the product wherein the lipstick is formulated so as to integrally contain the lipliner part such that the lipliner surrounds the lipstick, does not enable the product to be used reliably for outlining the lips as it is cylindrical of annular cross-section in shape such as to leave smudges on the lips when used. Again, the solution in which the part for outlining the lips is positioned only on one side of the part acting as the lipstick means that both lips can be outlined only by rotating the product body through 180° after outlining the upper lip. This makes this product relatively complex and difficult to use because of the need to correctly position the lip outlining part to correspond with the limit of each lip.

Also, most of the consumer products such as pharmaceutical products, personal hygiene/personal care products and adhesive products that are to be used or applied consecutively are available separately in one package. However, there has not been a device to hold two such items together in proximity so that the user can have easy access to both items simultaneously. Moreover, as the user must buy and use the two products separately, costs for buying the products are increased twice and it is inconvenient in use and carrying.

Therefore, there is a need in the art for an improved system that is simple and capable of holding two consumer products in an easy to use manner.

### SUMMARY

The present invention generally is a system for two consumer products, such as cosmetic products, pharmaceutical products, personal hygiene products and adhesive products, among others. The system provides for convenience in holding, storing and applying stick products and uses two different mechanisms independent of each other to control the two stick products.

According to an embodiment of the invention, the system comprises of a cap, a body and a means to propel-repel the individual products. The body comprises of two half shells wherein a partition wall is provided in the inner side of each of the half shell such that two chambers are formed upon assembling both the halves.

According to another embodiment of the invention, the partition wall in the internal side of each of the half shells is present at a position so as to result in the chambers of the system having different diameters to contain differing quantities of the products. Each of the chambers houses the two products and the propel-repel mechanism assemblies thereof. The propel-repel mechanism used for the products could be a general lipstick mechanism, a threaded screw mechanism, a sliding mechanism or any other suitable mechanism depending on the product to be dispensed. Further, for better and easier dispensing of the products, a means to propel-repel the products is provided which is attached to the mechanism assembly. The propel-repel means could be a rotor wheel, a slider or any other suitable means and could be positioned either at the base or on the lateral side of the body of the system.

According to another embodiment of the invention there are present two rings on the outer body of the system for dispensing the two products. Each of the chambers houses the two products and utilizes the propel-repel mechanism assemblies thereof. The rings are snap fitted to the outer body of the system and both of the rings work independently of each other to propel-repel the respective products. The inner diameter of each of the rings has teeth, which are connected to the teeth on the outer diameter of the rotor wheels, of the mechanism assemblies, in a gear and pinion like arrangement. As one of the rings is rotated, the rotor wheel of the mechanism assembly is also rotated due to the gear and pinion like arrangement and therefore causes the cup to propel or repel the product. According to yet another embodiment of the invention, both the chambers in the system utilize a threaded screw mechanism to propel-repel the products wherein the threaded screw assembly comprises of a threaded screw, a cup and a rotor wheel. The stick product sits inside the cup and the rotor wheel is threadedly attached to the screw below the cup. Rotation of the rotor in an anticlockwise direction and clockwise direction causes the screw to advance or retract, thereby propelling or repelling the product as per the requirement.

According to yet another embodiment of the invention, both the chambers in the system utilize an extended general lipstick mechanism assembly to dispense the products. The lipstick mechanism assembly comprises of a drive, helix and a cup to dispense the product. Further, for better and easier functioning of the same is provided a rotor wheel which is connected to the helix. The rotor wheel helps in propelling or repelling of the stick like product. The rotation of the rotor wheel causes a mechanism inside the chamber to move the stick, disposed in the cup, longitudinally with respect to the chamber. The stick may be moved to its highest position so that it is exposed out of the opening for application and correspondingly moved to its lowest position with respect to the chamber for storage.

According to yet another embodiment of the invention, both the chambers in the system house a slider mechanism to dispense the products wherein the slider mechanism assembly comprises of a cup, a cup holder and a slider. The cup holder has a cup in which the product sits and on the bottom end of the cup holder is a groove through which is attached the slider. The sliding movement of the slider button causes the cup holder to move in its opposite direction thereby causing the product to be exposed or stored.

According to yet another embodiment of the invention one of the chambers utilizes a threaded screw mechanism while the other chamber utilizes a general lipstick mechanism.

According to yet another embodiment of the invention one of the chambers utilizes a general lipstick mechanism while the other chamber utilizes a slider mechanism.

According to yet another embodiment of the invention one of the chambers utilizes a threaded screw mechanism while the other utilizes a slider mechanism.

According to yet another embodiment of the invention, the system addresses a sought after yet unfulfilled need of an easy and convenient application of a routine, where the user is getting both products in a convenient and easy-to-hold form and can apply in the easiest possible way.

According to yet another embodiment of the invention, the system of the present invention is, therefore, an incremental improvement of functionality use and reach of long existent product assembly. The system of the present invention could be used for any two consumer products in stick form. The system could also be used for two products that are generally used in tandem. It could be used for a wide variety of consumer and industrial products related to cosmetic, skin care, personal care, pharmaceutical, wound care, personal hygiene products and adhesive products, among others. The system of present invention can also provide for variation of similar products or for use of many combinations of complementary products as well.

These and further aspects which will be apparent to the expert of the art are attained by a system for two consumer products in accordance with the main claim.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an isometric view of a system according to one embodiment of the present invention;

FIG. 2 is an exploded view of the system of FIG. 1;

FIG. 3 is an isometric open view of the system of FIG. 1 showing the system utilizing a general lipstick and a threaded screw mechanism;

FIG. 4 is an isometric open view of a system according to another embodiment of the present invention showing the system utilizing a general lipstick and a slider mechanism;

FIG. 5 is an isometric view of the slider mechanism assembly of the system of FIG. 4;

FIG. 6 is an isometric open view of a system according to another embodiment of the invention showing the system utilizing an extended threaded screw mechanism for both the products; and

FIG. 7 is cross section view of the system of FIG. 6.

To facilitate understanding, identical reference numerals have been used, where possible, to designate identical elements that are common to the figures. It is to be noted, however, that the appended drawings illustrate only typical embodiments of this invention and are therefore not to be considered limiting of its scope, for the invention may admit to other equally effective embodiments.

### DETAILED DESCRIPTION

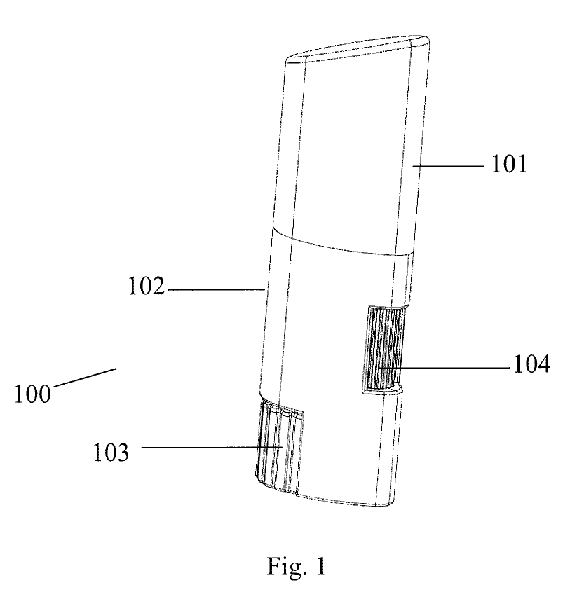

FIG. 1 is one embodiment of the present invention showing the system 100 for two stick consumer products that may be dispensed and applied independently. The system 100 consists of a cap 101, a body 102, a rotor wheel 103 at the bottom of the body and a rotor wheel 104 at the lateral side of the body. The cap 101 and the rotors 103 and 104 may be formed from any suitable metal or a polymeric material such as acrylonitrile butadiene styrene or any other suitable material.

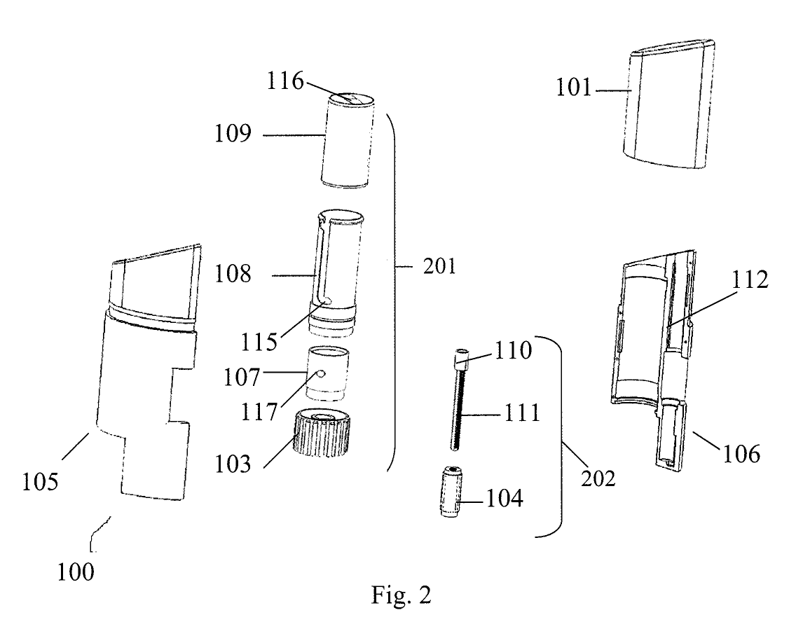

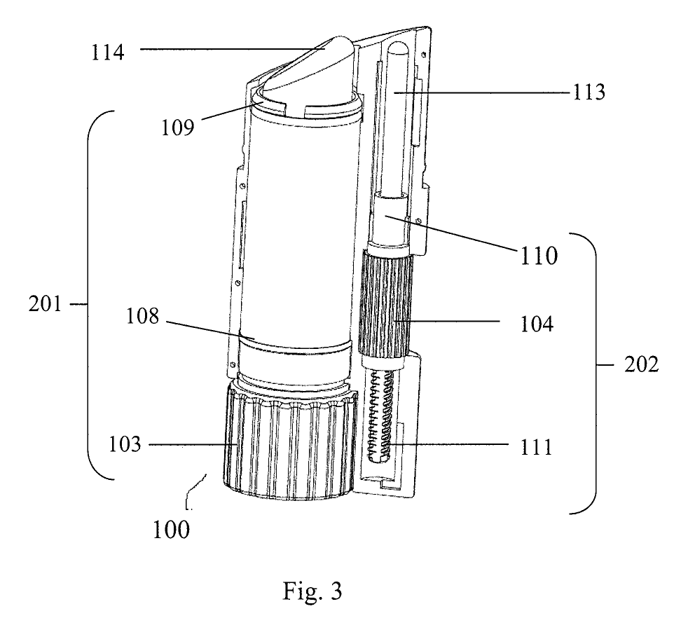

Referring to FIGS. 2 and 3, the body 102 of the system 100 comprises of two half shells 105 and 106. In the inner side of each of the half shell is provided a partition wall 112 such that when the two halves are joined together they form two chambers inside the body 102. The two halves could be made of any polymeric material such as acrylonitrile butadiene styrene or any metal such as aluminium, steel, aluminium alloys, ZAMAC (Zinc Aluminium Magnesium and Copper alloy) or any other suitable material. The chambers could be of any form or shape and have a base and an opening for the products to be housed. One of the chambers utilizes a general lipstick mechanism assembly 201 while the other utilizes a threaded screw mechanism assembly 202 for propelling or repelling the respective products.

The threaded screw assembly 202 comprises a cup 110, a screw 111 and the rotor wheel 104. The rotor wheel 104 has complementing threads in its inner diameter through which it is screwed on to the screw 111. The assembly is so arranged that the rotor wheel 104 is positioned below the cup 110. As per FIG. 3, the stick product 113 sits inside the cup 110. Anti-clockwise rotation of the rotor wheel 104 causes the product 113 disposed in the cup 110 to propel upwards with respect to the chamber while clockwise rotation brings the cup 110 back to its initial position. The threaded screw mechanism 202 dispenses the product 113 while the general lipstick mechanism 201 assembly dispenses the second product 114.

The lipstick mechanism assembly 201 comprises a drive 108, a helix 109 and a cup 107 to dispense the product 114. The rotor wheel 103 is provided at the base which is connected to the drive 108. The drive 108 includes a gliding groove 115 formed thereon. The inner wall of the helix 109 includes a spiral shell guiding trench 116. The stick product 114 is disposed on the upper portion of the cup 107. The outer wall of the cup 107 includes a guiding pillar 117 that can move in the guiding groove 115 and the spiral shell guiding trench 116 of helix 109. In combination, the cup 107 is disposed in the drive 108 allowing the guiding pillar 117 to fall into the gliding groove 115. The cup 107 is free to move vertically within the drive 108 with a limited range. The helix 109 is then harnessed outside of the drive 108 also allowing the guiding pillar 117 to fall into the spiral shell guiding trench 116. Finally, the rotor wheel 103 is assembled to the bottom portion of the drive 108 and is affixed thereon. Rotor wheel 103 is rotated to use the stick product. The drive 108 is rotated in response to the rotation of the rotor wheel 103. The cup 107 is also rotated in response to the rotation of the guiding pillar 117. Since the helix 109 does not move, the cup 107 can then move upward or downward along the guiding groove 115 driven by the movement of the guiding pillar 117 in the spiral shell guiding trench 116. The stick product 114 can then be propelled and repelled within the drive 108.

The material for cup 107 and 110 and screw 111 could be polyoxymethylene while polypropylene could be used for the drive 108 and acrylonitrile butadiene styrene for helix 109. The aforementioned materials are an example, however any suitable material could be used for various parts of the mechanism assemblies.

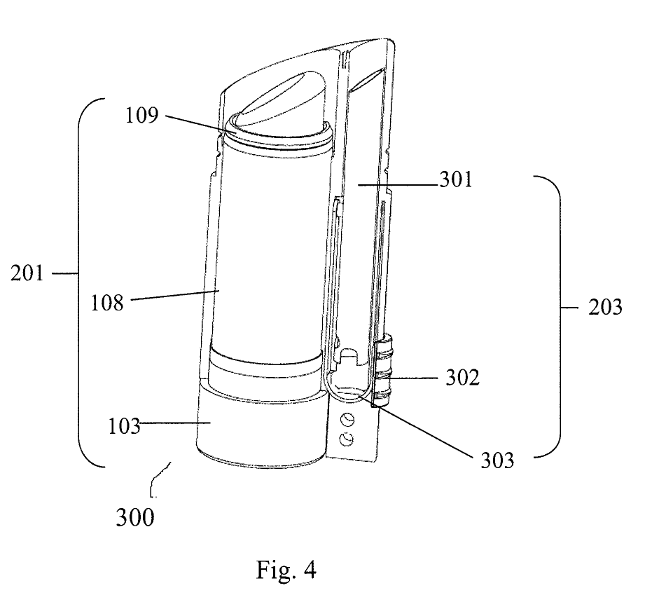

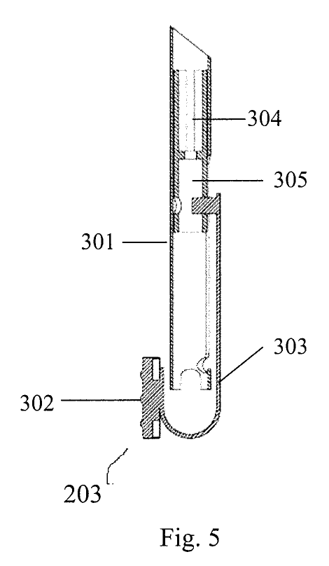

FIG. 4 illustrates another embodiment of a system 300 for two consumer products. The system 300 utilizes a slider mechanism 203 in one of the chambers and a general lipstick mechanism 201 in the other chamber. The lipstick mechanism assembly 201 comprises of the drive 108, the helix 109, the cup 107 and the rotor wheel 103 at the base to dispense the product 114. The slider mechanism assembly 203 comprises of a metallic housing 301, a slider button 302 and a slider 303. Referring to FIG. 5, in the metallic housing is housed a cup holder 305 that holds the cup 304. The slider 303 is attached with the cup holder 305 through a groove present in it. The slider button 302 is present at the end of the slider 303 for the user to slide the product up or down as per the requirement. The sliding movement of the slider button 302 causes the cup holder 305 to move in its opposite direction thereby causing the product to be exposed or stored.

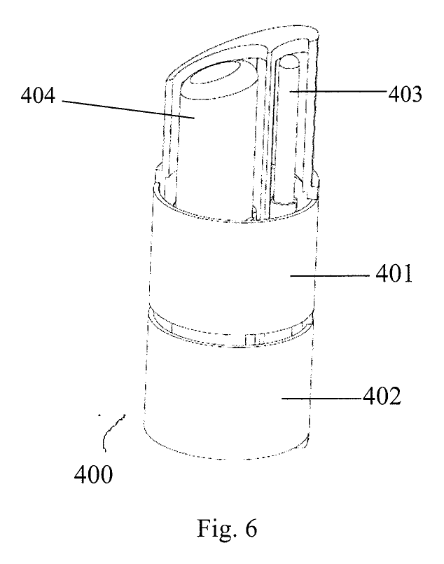

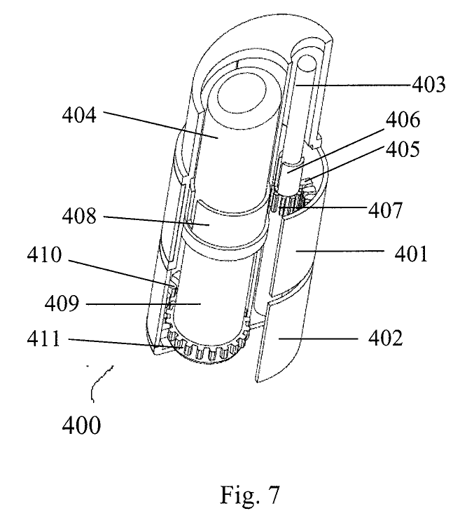

FIGS. 6 and 7 depict another embodiment of a system 400. The system 400 includes two rings 401 and 402 on the outer body of the system 400 for user to dispense the two products 403 and 404. The rings 401 and 402 are snap fitted to the body of the system 400. In the inner diameter of the rings 401 and 402 are present teeth 405 and 410 respectively. Both the chambers utilize threaded screw mechanism to dispense the products. The product 403 in one of the chambers sits in the cup 406 below which is placed a rotor wheel 407. The rotor wheel 407 has threads in its inner diameter through which it is screwed on to the screw that holds the cup 406. The outer diameter of rotor wheel 407 has teeth, which are connected, with the teeth 405 in the inner diameter of the ring 401 in a gear and pinion like arrangement. As the ring 401 is rotated, the rotor wheel 407 is also rotated due to the gear and pinion like arrangement and therefore causes the threaded screw with cup 406 to propel or repel the product 403. The product 404 in the other chamber sits in the cup 408 below which is placed a rotor wheel 409. The rotor wheel 409 has threads in its inner diameter through which it is screwed on to the screw that holds the cup 408. The outer diameter of rotor wheel 409 has teeth 411 that are connected with the teeth 410 in the inner diameter of the ring 402 in a gear and pinion like arrangement. As the ring 402 is rotated, the rotor wheel 409 is also rotated due to the gear and pinion like arrangement and therefore causes the threaded screw with cup 408 to propel or repel the product 404.

The two rings 401 and 402 could be made of any metal such as aluminium, steel, aluminium alloys, ZAMAC (Zinc Aluminium Magnesium and Copper alloy) or any polymeric material such as acrylonitrile butadiene styrene or any other suitable material. Also, all the parts of the system of the present invention could be made from either any metal or any polymeric material or any other suitable material. Although the above description and drawings show the system, and in particular the chambers thereof, being cylindrical, the shapes and profile cross section thereof are not limited to the same.

The system of the present invention addresses the need of an easy and convenient application of a routine where the user is getting both products in a convenient and easy-to-hold form. Further, as the size, form and use retain familiarity with other long existing products, making it easy for a user to apply the products in a familiar way.

The system of the present invention could be used for any two consumer products in stick form. The system could also be used for two stick products that are generally used in tandem. It could be used for cosmetic products, pharmaceutical products, personal hygiene products and adhesive products, among others. The system of present invention can also provide for variation of similar products for example different shades or flavors of lip-balm, two fragrances of deodorant sticks. The system of the present invention could allow for use of many combinations of complementary products as well, for example insect repellant and anti-itch, sun block and burn treatment use and the like.

Various examples of the products where the system of the present invention could be used are but not limited to a lipstick and a lipliner, a lipstick and a lip gloss, two lipsticks of different shades, a lipstick and a lip primer, a lipstick and a lipbalm, eyeshadow and eyeliner, two eyeshadows of different shades, an eyeshadow and an eyeprimer, a foundation stick and a concealer or a correcting stick, a blush and a concealer, acne treatment formulation and concealer, blemish concealer and skin treatment stick, two skin treatment formulations in stick form, pain relieving balm and antiseptic stick, a deodorant stick and an antiperspirant stick, sun care products in stick form such as sunscreens, skin emollients in stick form, insect repellents and the like, adhesive sticks, a primer and an adhesive, a catalyst and a resin, shaving soap sticks, coloring sticks and so forth.

Thus, the system provides a simplified, inexpensive, and efficient system that achieves all the enumerated objectives and obtains new results in the art.

While the foregoing is directed to embodiments of the present invention, other and further embodiments of the invention may be devised without departing from the basic scope thereof, and the scope thereof is determined by the claims that follow.

What is claimed is:

1. A system for holding, storing and applying two stick products, said system comprising a cap, a body, a propelling or repelling means for each of the products, wherein:
the body comprises of two half shells, wherein each of the said half shells is having a partition wall in its inner side which results in the formation of two chambers when the half shells are joined together wherein
each of the chambers house the two products and propel-repel mechanism assemblies thereof, wherein each of the products is controlled by two mechanism assemblies independent of each other.

2. The system according to claim 1 wherein the partition wall in the inner side of each of the half shells is at a position so as to result in the chambers of the system having different diameters to contain differing quantities and types of the products.

3. The system according to claim 1 wherein the chambers have a base and an opening for the products to be housed.

4. The system according to claim 1 wherein the propel-repel means is a rotor wheel or a slider.

5. The system according to claim 1 wherein at least one of the propel-repel mechanism assemblies is a general lipstick mechanism, a threaded screw mechanism or a sliding mechanism.

6. The system according to claim 5 wherein at least one of the chambers utilizes a lipstick mechanism assembly.

7. The system according to claim 6 wherein said lipstick mechanism assembly comprises of a drive, a helix, a cup and a rotor wheel to propel-repel the product.

8. The system according to claim 7 wherein said rotor wheel is connected to the helix.

9. The system according to claim 5 wherein at least one of the chambers utilizes a threaded screw mechanism assembly.

10. The system according to claim 9 wherein the threaded screw mechanism assembly comprises of a cup, a screw and a rotor wheel to propel-repel the product.

11. The system according to claim 5 wherein at least one of the chambers utilizes a slider mechanism assembly to propel-repel the products.

12. The system according to claim 11 wherein the slider mechanism assembly comprises of a cup, a cup holder, a slider and a slider button.

13. The system according to claim 12 wherein the slider is connected to the cup holder through a groove in the cup holder.

14. The system according to claim 1 wherein the products in the chambers comprise at least one of lipstick, a lipliner, a lip gloss, a lip primer, a lipbalm, an eyeshadow, an eyeliner, an eyeprimer, a foundation stick, a concealer or a correcting stick, a blush, a concealer, a deodorant stick, an antiperspirant stick, an acne treatment formulation, skin treatment formulations in stick form, sun care products in stick form such as sunscreens, skin emollients in stick form, pain relieving balm, antiseptic stick, insect repellent, anti-itch formulation, adhesives, catalyst, shaving soap sticks and coloring sticks.

15. A system for holding, storing and applying two cosmetic stick products, said system comprising a cap, a body and two rings for propelling or repelling the individual products wherein:
the two rings are snap fitted onto the outer body of the system;
the body comprises of two half shells, wherein each of the said half shells is having a partition wall in its inner side which results in the formation of two chambers when the half shells are joined together wherein
each of the chambers house the two products and propel-repel mechanism assemblies thereof, wherein each of the products is controlled by two mechanism assemblies independent of each other.

16. The system according to claim 15 wherein the partition wall in the inner side of each of the half shells is at a position so as to result in the chambers of the system having different diameters to contain differing quantities of the products.

17. The system according to claim 15 wherein the chambers have a base and an opening for the products to be housed.

18. The system according to claim 15 wherein the propel-repel mechanism assemblies used for the cosmetic products in the chambers is a general lipstick mechanism, a threaded screw mechanism or a combination thereof.

19. The system according to claim 15 wherein the inner diameter of each of the rings has teeth that are connected to the teeth on the outer diameter of the rotor wheels, of the mechanism assemblies, in a gear and pinion like arrangement.

20. The system according to claim 15 wherein rotation of the each of the ring causes the rotor wheel of the mechanism assembly to rotate and propel or repel the product.

21. The system according to claim 15 wherein the products in the chambers comprise at least one of lipstick, a lipliner, a lip gloss, a lip primer, a lipbalm, an eyeshadow, an eyeliner, an eyeprimer, a foundation stick, a concealer or a correcting stick, a blush a concealer, a deodorant stick, an antiperspirant stick, an acne treatment formulation, skin treatment formulations in stick form, sun care products in stick form such as sunscreens, skin emollients in stick form, pain relieving balm, antiseptic stick, insect repellent, anti-itch formulation, adhesives, catalyst, shaving soap sticks and coloring sticks.

22. A system for holding, storing and applying two cosmetic stick products, said system comprising a cap, a body and a means for propelling or repelling the individual products wherein;
the body comprises of two half shells, wherein each of the said half shells is having a partition wall in its inner side which results in the formation of two chambers when the half shells are joined together wherein;
the partition wall in the inner side of each of the half shells is at a position so as to result in the chambers of the system having different diameters to contain differing quantities of the products; and
each of the chambers house the two products and propel-repel mechanism assemblies thereof, wherein;
each of the products is propelled or repelled by two mechanism assemblies independent of each other; and
said system optionally comprising two rings on the outer body for propelling or repelling the individual products wherein the two rings are snap fitted onto the outer body of the system wherein the inner diameter of each of the rings has teeth that are connected to the teeth on the outer diameter of the rotor wheels of the mechanism assemblies, in a gear and pinion like arrangement and wherein rotation of the each of the ring causes the rotor wheel of the mechanism assembly to rotate and propel or repel the product.
